(19) United States
(12) Patent Application Publication
(10) Pub. No.: US 2009/0307718 A1
(43) Pub. Date: Dec. 10, 2009

(54) Method and Apparatus for User Configurable Table for Blocking or Allowing of Video and Audio Signals

(75) Inventor: Hing S. Tong, Santa Fe Springs, CA (US)

Correspondence Address: KLEINBERG & LERNER, LLP, 1875 CENTURY PARK EAST, SUITE 1150, LOS ANGELES, CA, 90067, US

(73) Assignee: WESTINGHOUSE DIGITAL ELECTRONICS, LLC, Santa Fe Springs, CA (US)

(21) Appl. No.: 12/135,081

(22) Filed: Jun. 6, 2008

(51) Int. Cl. H04N 7/16

(52) U.S. Cl. 725/28

(57) ABSTRACT

A method of selectively blocking television programming content wherein the user may use a free-form textual input means to input one of a number of various keywords, times, viewers, dates, ratings, programs or any number of keyword-based input. The method is capable of blocking content, based upon this input, without reference to any pre-determined ratings system. The method may utilize programming-related information available in an on-screen programming guide or other similar informational system in order to selectively block content.

### BACKGROUND

1. Field of the Invention

This invention relates to blocking audio and video signals. More specifically, a software engine in the television that permits user configurable parameters for selectively blocking audio and video signals.

2. Description of the Related Art

In the United States, the Federal Communications Commission has made it mandatory that all television sets 13″ and larger manufactured after Jan. 1, 2000 must features to block display of television programming based on rating. This type of product is generally referred to as parental controls. One method for providing parental controls such as content blocking is commonly referred to as the V-Chip.

The original V-Chip technology allowed parents to control whether or not content was viewable on a television based on the program's rating. The ratings are established by the National Association of Broadcasters, National Cable Television Association and Motion Picture Association of America.

The ratings information is sent to television sets in the form of data encoded within the broadcast signal. More specifically, the rating is broadcast on line 21 of the analog broadcast signal using the extended data service (“XDS”) protocol and within the regional ratings table (“RRT”) table of the digital broadcast signal. The V-Chip is able to detect the rating, then compares it to what a user has requested be blocked based on the user's configuration of the V-Chip. If the program is outside what the user has configured as acceptable, the program is blocked.

Users of V-Chip compliant televisions may use the televisions to set ratings standards for televisions in a give household. Access to the V-Chip configuration algorithm is password protected. Password protection ensures that only parents are able to maintain control over what programming is blocked and what programming is viewable.

The V-Chip technology is not a complete parental control or content blocking solution in that it is solely based on ratings and does not take into account the actual content of the programming. Such an approach is not flexible for parents who do not agree with the ratings system or who want more control over what they feel is appropriate for their children to watch. Furthermore, V-Chip technology does not have the ability to block based on time or channel.

The V-Chip and other similar technology is further limited because the blocking scheme that is employed is global for all viewers and all programs. It does not take into account that there are different viewers that view the same television but would have different blocking needs. For example, a teenager viewer would not need to have as many viewing restrictions as an elementary school child.

Extensions to the V-Chip parental control technology have been created which allow ratings to be updated remotely. These extensions enable additional RRT tables to be received and implemented by a television. However, these systems are still, largely if not entirely, ratings-based. In some instances, they are implemented on a per-user basis, but in most cases, these systems work for all users as if they are the same.

Other blocking technologies have expanded beyond pure ratings blocking. However, they still suffer from the limitations of only blocking based on certain criteria and are not a completely customizable to allow parents to define their own blocking parameters. As a result, there is a need to provide additional flexibility in allowing parents to block programming they, not others, deem objectionable from being viewed by their children.

### SUMMARY OF THE INVENTION

The software engine described in the following specification overcomes the limitations of the prior art, such as the V-Chip, by permitting users to customize the blocking parameters to suit their own individual preferences. This software engine is able to overcome the limitations by using a free form text input system which gives the user unlimited flexibility in setting the blocking parameters or conditions.

This invention is able to overcome the limitations because of the convergence between television sets and computers resulting in television sets becoming more like computers with greater computing and processing power. This increase in processing power afforded by modem computer central processing units, integrated into digital televisions, allows for the implementation of a software engine that can block content based on more then the data encoded on line 21 of an XDS broadcast signal for the rating or the RRT data encoded on Program and System Information Protocol (“PSIP”) of the digital broadcast signal for the rating.

That is not to say that this software engine renders the encoded ratings data useless, it can block content based on the encoded ratings data and then do more. For example, in addition to blocking based upon rating, this software engine can also block entire periods of time, based on data contained in the program description in an on-screen guide (“OSG”) as well as all the programming on a particular channel. By doing so, the software engine can become more then just a tool for parents to protect their children from television content they feel is inappropriate, it is also a tool to enforce parental viewing restrictions, such as curfews and channel restrictions. If the television set can access program descriptions through an OSG, the Internet or other computer network, then the software engine has the ability to block based on that information as well.

Text input for the software engine is with an input device such as a remote control, keyboard or any other input device capable of alphanumeric input. The software engine forms a recipe from the text input. A recipe is a set of conditions and actions to be taken when those conditions are met. The conditions can be anything related to the television broadcast. The software engine can create, store and use one or more recipes.

Another feature that this invention can support as a result of the increased processing power is the ability to support multiple viewers through a user ID and password system. In the preferred embodiment, a user may “login” to the television in a manner similar to that known with computers. If a user so desires, this functionality may be disabled or the television may assume that a particular user is the default login, for example, the login with the most restrictions. However, once a user has logged into the system, the program restrictions or ability to add additional program restrictions (dependant upon the user who logs in) will be available.

The use of the recipe system in conjunction with the ability to set multiple viewers allows blocking to be individual tailored. For example, a high school student will have different blocking then an elementary school student. Each viewer or class of viewers is assigned a user ID and password. A user ID can be assigned multiple recipes, and a recipe can be assigned to multiple user IDs. When the television is turned on, the user ID and password must be entered. After successful input of user ID and password, all recipes assigned to that user ID will be activated. If a new viewer replaces the previous viewer, a new user ID and password can login while the television is operating to allow a different set of recipes to be activated without needing to restart the television.

After a user's set of recipes have been activated, the software engine will compare the recipes with the program to determine if it may be viewed or not. A few instances where a check may be required includes, but are not limited to: when the TV is turned on, at the transition between programs, transition between channels, date change, time change, input change, new user login or at predetermined times. Yet another feature of the software engine will allow the user to determine when, if any of these, the software engine will compare the recipe with the programming.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is an exemplary illustration of the text input box according to the present invention;

FIG. 2, made up of 2A and 2B, are an exemplary illustrations of the text input box and the line-by-line input with sample entered text according to the present invention;

FIG. 3 is an exemplary illustration of the input summary screen according to the present invention;

FIG. 4 is an exemplary illustration of the recipe layout screen according to the present invention;

FIG. 5 is an exemplary illustration if the parental control summary screen according to the present invention; and

FIG. 6: is a block diagram showing the operational sequence for generating and using recipe.

### DETAILED DESCRIPTION OF THE DRAWINGS

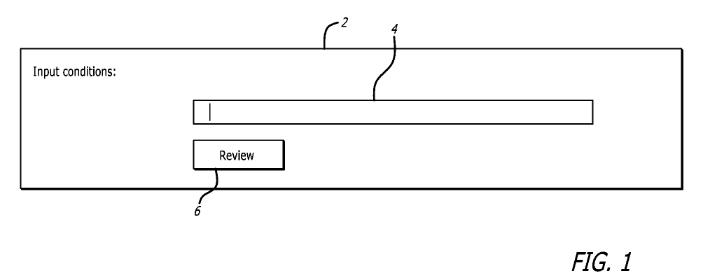

Turning first to FIG. 1, there is an illustration of the text input box 2. The user uses an input device, keyboard, remote control or any other input device known to those skilled in the art, to input text into the text input field 4. The text that the user inputs in the text input field 4 is completely free form, similar to the input of an Internet search engine. The text that the user inputs are the conditions and the action to take when those conditions are met.

In order to improve input alternative embodiments can contain additional features. In one alternative embodiment, the software engine will have a user viewable vocabulary library. The vocabulary library will be useful for those users that are not fully aware of all the terms that the software engine can utilize for blocking. Yet another embodiment of the invention with a feature to improve user input allows for the software engine to store frequently used text strings. In this embodiment, frequently used text strings are stored by the software engine and then recalled to take the place of repetitive entries.

The conditions can be any combination of parameters. A few example parameters can include, but are not limited to, start time, channel, keywords, show title (or portion thereof), episode number, length, end time, actor, actress, director, genre, date and rating. The action taken will be either allow or block. The advantage to free form text input is that the user is allowed complete flexibility in deciding what to block and are not limited to blocking based on predefined parameters. Furthermore, users can set as many or as few conditions as they desire.

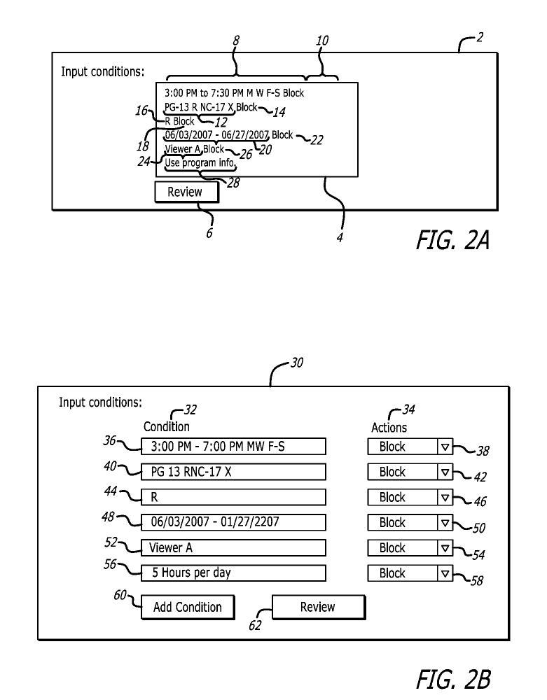

Turning next to FIG. 2, there are two illustrations of the text input box 2 with some sample text entered. The first, FIG. 2A, includes sample text to illustrate a feature of the preferred embodiment of the text input box 2 and is not meant to limit the format or what can be entered into text input field 4. Specifically, FIG. 2 illustrates is that the user inputted text could be entered on multiple lines. Initially, the text input field 4 only displays 1 line in FIG. 1. However, as illustrated in FIG. 2, text input field 4 automatically expands to accommodate additional lines.

FIG. 2A further illustrates that the user inputs a single condition per line into the text input box 2. Although, the user can input all the desired conditions onto a single line, limiting one condition per line is advantageous for organizational purposes. The user is not limited to the number of lines that may be entered. When the user is done inputting text, Review button 6 is pushed, so that before the recipe is created, the user may review the entered conditions and corresponding actions.

FIG. 2A includes a series of instructions that are intended to be self-explanatory, but for purposes of clarity will be described herein. The first condition 8 is “3:00 PM to 7:30 PM M W F-S.” This condition 8 is intended to represent a time period. On every Monday, Wednesday, Friday, Saturday and Sunday, television will perform a specific action. The first action 10, corresponding to the first condition 8, is to “Block.” Accordingly, during that time period on those days, the television will not display any content.

The second condition 12 is “PG-13 R NC-17 X” and the second action 14 is “Block.” As can be seen and as has been described, the present invention can utilize program RRT tables or XDS tables to block content. Alternatively, these ratings may be received directly from an OSG or from the information content that makes up an OSG.

The third condition 16 is “R” and the third action 18 is “Block.” As above, this condition 16 blocks “R” rated content. The fourth condition 20 is “06/03/2007-06/27/2007” and the fourth action 22 is “Block.” This listing sets a time-frame for the blocking process. In one embodiment, this may be the only condition, selectively blocking all content during that period. In alternative embodiments, this defines the limit during which the other conditions will be enforced. The fifth condition 24 is “Viewer A” and the fifth action 20 is “Block.” In the preferred embodiment, this causes the remaining conditions to be applied to “Viewer A” only. In alternative embodiments, this command may cause all content to be blocked for “Viewer A.”

The final condition 28 is “Use program info.” This command instructs the method of the present invention to use any programming information available, for example in the data pertaining to a program encoded into the program description or any data contained in an accessible OSG. If this input is not added, the television will do it's best to conform to the requirements of the blocking recipe or “scheme” given the information it contains. It will, in the preferred embodiment, block content which conforms to any of the “block” instructions to which it can compare data which is accessible.

Referring now to FIG. 2B, an alternative input mechanism is shown in order to demonstrate that the input method may vary in alternative embodiments, without varying from the intended scope of the present invention. In this embodiment, the input box 30 takes on a different form. There are two columns, a condition column 32 and an actions column 34. Each column corresponds to a text box, as described above. A user may input a particular condition and in the actions column 34, may select one or more actions to take with regard to a particular condition.

The first condition box 36 includes the same “3:00 PM-7:30 PM M W F-S” as above. The corresponding actions box 38 contains “Block” as above. In the preferred embodiment, the actions dropdown 38 and all other actions dropdowns contain two or more options, such as “Block” “Allow” or other options. The next conditions box 40 includes “PG-13 R NC-17 X” and the corresponding actions dropdown 42 contains “Block.” The next conditions box 44 contains “R” and the corresponding actions dropdown 46 contains “Block.” The next conditions box 48 contains “06/03/2007-06/27/2007” and the corresponding actions dropdown 50 contains the word “Block.”

The next conditions box 52 contains “Viewer A” and the corresponding actions dropdown 54 contains the word “Block.” Finally, the last conditions box 56 contains “5 hours per day” and the corresponding actions dropdown 58 contains “Allow.” This will allow a viewer to watch up to 5 hours per day of television. This entry is intended to demonstrate how a rule may be to “allow” something as well as to “block.” In the preferred embodiment, the “allow” commands will override any overarching “blocking” recipe.

Finally, the add condition button 60 allows a user to add a condition to the list, effectively adding an additional condition box and actions dropdown to the list. The review button 62, as above, causes the conditions and actions to be reviewed by the present system and formulated into a recipe for content blocking. A user may then review and, if necessary or desired, subsequently amend the blocking recipe.

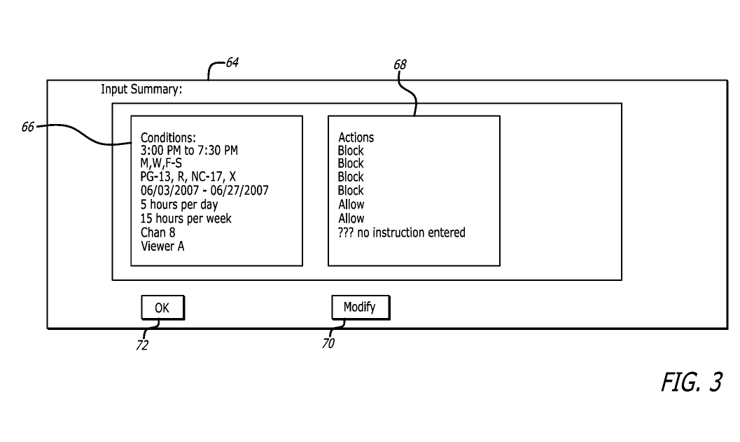

Turning now to FIG. 3, there is an illustration of the input summary screen 64. After the user has input conditions and actions in the text input field 4 (see FIG. 1) and reviewed, the software engine identifies and displays it in the input summary screen 64 before the recipe is generated.

Input summary screen 64 consists of a conditions column 66 and an actions column 68. The conditions column 66 lists all the conditions that the software engine was able to identify. The actions column 68 lists all actions that the software was able to identify. Each of the conditions and actions identified are shown on one line for clarity. Each condition listed in the conditions column 66 is associated with the immediately adjacent action in the action column 68. Typically, the actions in the actions column 66 will be “Block” or “Allow.”

Another function that the input summary screen 64 has is to inform the user of conditions that are not fully defined or that the software engine does not understand. If such a condition exists, then the software engine does not understand, then the adjacent action will not be the typical “Block” or “Allow.” Instead, a third message, warning the user that no instruction was understood may provided. One example, such as “No Instruction Recognized,” may be displayed in the action column 68. If there are any conditions that need to be corrected, the user may select the modify button 70 which causes the on screen display to return to the text input field 4 (see FIG. 1) and allows the user to make any desired corrections. If the user approves of the conditions and corresponding actions that the software engine has identified, the user may select the OK button 72 to generate the recipe.

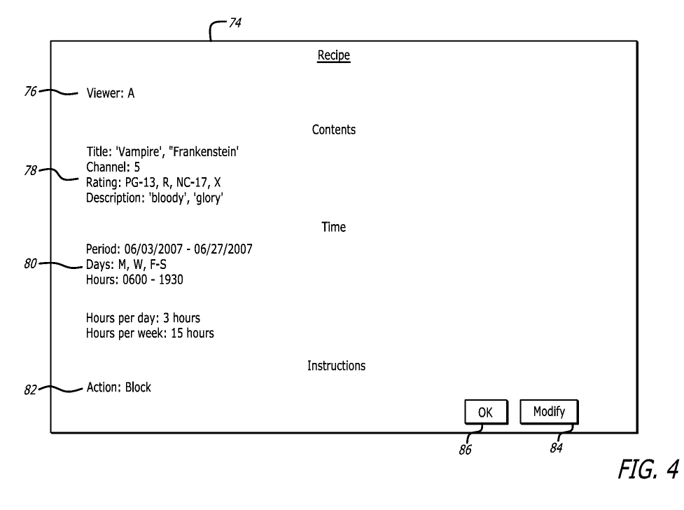

Turning to FIG. 4 an exemplary illustration of the recipe layout s screen 74 is shown. In the recipe layout screen 74, the software engine displays the created recipe based on the text input into the text input field 4 (see FIG. 1) and accepted in the input summary screen 64. The recipe shows the results of the text input results which the television will then be instructed to block. The recipe may also be understood to be a “scheme” or “listing.”

In order to make viewing the recipe easier, the software engine categorizes all the entered conditions. In the illustrated embodiment, a few categories are displayed. These example categories are viewer 76, contents 78, time 80 and instructions 82. The viewer category 76 lists all the viewers to whom this recipe applies. The contents category 78 lists all content based conditions found in the recipe. The contents category 78 lists the contents that, if present in a given program, will be blocked under this recipe. In other embodiments, these contents in the contents category 78 may apply conditions which all must be met in order to apply a given recipe.

Time and date conditions are found in the time category 80. IN the preferred embodiment, the recipe will be applied if all conditions are met. In alternative embodiments, the recipe will be applied (and thus content blocked) if any of the conditions are met. The action taken is listed in the instructions category 82. Generally, this action will be to “Block.” However, in some cases content may be specifically “allowed.” These categories are exemplary of the most common categories the users will utilize. However, users are not limited to these categories.

Users may define their own categories utilizing an on screen menu system. Users may indicate which portions of the program information available to the television to access in order to search for blocked content, keywords or other elements. The software engine then incorporates the additional categories and allows the users to input conditions in those forms. Accordingly, the software engine provides for an unlimited number of categories for users to define.

If the user wishes to make any adjustments to the recipe based on problems that arose in the input summary screen 64 or if a user would like to change something in the recipe layout screen 74, the user may select the modify button 84. Otherwise, the user may select the OK button 86 to confirm the recipe creation.

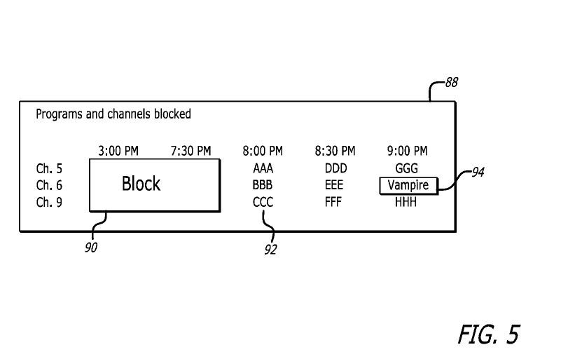

Turning next to FIG. 5, there is an exemplary illustration of a parental control summary screen 88. The parental control summary screen 88 is not part of the recipe generation process, but is a part of the software engine. After recipe generation, the user may view the parental control summary screen 88 through a menu option or remote control button. This screen may, alternatively, be integrated directly with the on-screen guide used to show the upcoming programs on the television.

The function of the parental control summary screen 88 is to give users the ability to view the programming that will be blocked. The blocked programming appears in a different color (or other indicia) on an electronic program guide or a screen similar to an electronic program guide. This screen is useful to see the cumulative effect of all the assigned recipes for a given viewer and to easily determine what content is blocked and what is allowed. Users can also easily see upcoming programs, time periods or channels that they may want to block.

In order to highlight what is being blocked, the software engine will use a color coding system. In other embodiments, “stars” or “cross hatches” may be added to the program's description. The indicia that the program is or will be blocked according to the current recipe or series of recipes will vary from television to television, but its intended that this method provide means by which a “preview” of blocked content may be seen, easily, by a user after creating one or more recipes.

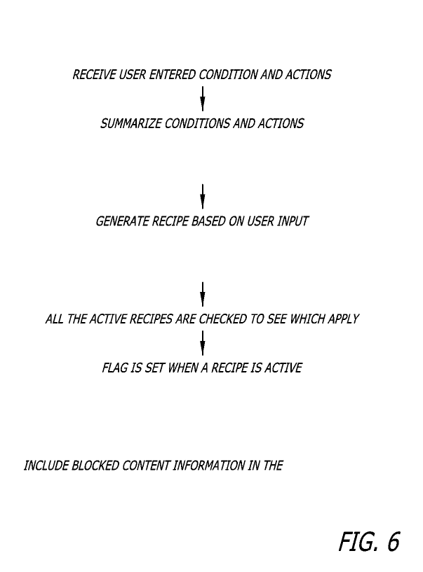

Finally turning to FIG. 6, there is a block diagram showing the method of recipe creation and use. Recipe creation begins in step 96, when the user enters text into the text entry box 4 (see FIG. 1). This text takes on the form described above, utilizing conditions and actions.

Following text entry in step 96, the software engine identifies and summarizes all the conditions and actions taken when the conditions are satisfied in step 98. In step 98, the user can either accept or modify the conditions and actions based on the summary generated by the software engine. If the user modifies the conditions, they return to Step 96 and modify the text that has been entered in the text entry box 4 (see FIG. 1).

When the user is satisfied with summary of conditions and accepts the summary that the software engine has generated in step 100, the software engine generates the recipe in step 102. After the software engine has generated the recipe, the user can still modify the recipe in step 104. If the user chooses to modify the recipe under Step 104, the process may begin again at step 96, wherein a user may modify the text entered into text entry box 4.

The software engine utilizes the generated recipe beginning in step 106. In step 106, the user logs into the television (or a default login is used) and the active blocking recipes are applied by the television. In step 108, the software engine sets a flag on the active recipe. The flag allows a user to temporarily enable or disable the parental control function from on-screen menu. In step 110 instructions the software engine to check the programming against a recipe whenever an event that requires such a check occurs. Such events are typically a channel change, new user ID logs in, television power on and other similar situations. If the parameters satisfy the conditions of the recipe, the action specified in the recipe will be carried out. Typically, that will be either allowing or blocking of the program.

In step 106, whenever a viewer logs in instructs the software engine to check all the active recipes to see which ones apply. The software engine will check to see which recipes apply at user specified events. A few typical events include, but are not limited to when: a television is powered on, a different viewer begins to watch the television, the channel changes and the program changes.

If at any time any viewer wants to see a summary of what the cumulative blocking effect and if the television can access an electronic program guide, the software engine can display through a graphic user interface what is being blocked in step 112. In step 112, the blocked channels, time periods and programs are labeled as blocked on the electronic program guide. An additional advantage to step 112 is that the user can easily review upcoming programs to ensure that everything that the user desires to be blocked is blocked and to anticipate new content that needs to be blocked.

1. A method of creating recipes for selective blocking of audio and video content on a television comprising the steps of:
receiving input of a first condition regarding audio and video content;
receiving input of a first action to take in response to said first condition;
analyzing said first condition and said first action; and
deriving meaning from said first condition and said first action to thereby create a logical expression and command which may be used by a television to selectively block said audio and video content.

2. The method of claim 1, wherein said input takes the form of one selected from the following:
a. a date;
b. a date range;
c. a keyword;
d. a television show title;
e. a subject matter;
f. a director;
g. an actor;
h. a time;
i. a time range; and
j. a viewer.

3. The method of claim 1, wherein said input takes the form of a television program rating.

4. The method of claim 3, wherein said television program rating is transmitted in the regional rating tables received by the television.

5. The method of claim 3, wherein said television program rating is transmitted in the extended data service received by the television.

6. The method of claim 1, further comprising the additional steps of:
receiving input of a second condition regarding audio and video content;
receiving input of a second action to take in response to said first condition;
analyzing said second condition and said second action; and
deriving meaning from said second condition and said second action to thereby create a logical expression and command which may be used by a television to selectively block said audio and video content.

7. The method of claim 1, wherein said first condition and said first action are received in the form of textual input.

8. The method of claim 6, wherein said second condition and said second action are received in the form of textual input.

9. A method of selectively blocking audio and video content on a television comprising the steps of:
maintaining at least one selective blocking recipe;
reviewing said recipe at pre-determined times;
comparing said recipe to available information pertaining to a television program; and
selectively blocking said television if said recipe indicates that the program should be blocked.

10. The method of claim 9, wherein said selective blocking recipe includes at least one condition input by a user through text-based input.

11. The method of claim 9, wherein said selective blocking recipe includes at least one action input by a user through text-based input.

12. The method of claim 9, wherein said pre-determined times include one of the following:
a. television power on;
b. television channel change;
c. television program change;
d. periodically; and
e. new user login.

13. The method of claim 9, wherein said available information includes data from one of the following:
a. television programming guide information;
b. regional ratings table;
c. extended data service;
d. user input;
e. internal calendar;
f. internal clock; and
g. user login information.

14. The method of claim 9, wherein said comparing step includes comparing a user-inputted condition, present in said recipe, to an attribute of a given television program

15. The method of claim 9, wherein said blocking step includes performing a user-inputted action, present in said recipe.

16. The method of claim 15, wherein said action is to block said television program.

17. A method of selectively allowing audio and video content on a television comprising the steps of:
maintaining at least one selective allowance recipe;
reviewing said selective allowance recipe at pre-determined times;
comparing said selective allowance recipe to available information pertaining to a television program; and
selectively allowing viewing said television if said selective allowance recipe indicates that the program should be allowed.

18. The method of claim 17, further comprising the additional steps of:
maintaining at least one selective blocking recipe;
reviewing said selective blocking recipe at pre-determined times;
comparing said selective blocking recipe to available information pertaining to a television program and to said selective allowance recipe; and
selectively blocking viewing of said television if said selective blocking recipe indicates that the program should be blocked and further if said selective allowance recipe does not indicate that the program should be allowed.

19. The method of claim 17, wherein said pre-determined times include one of the following:
f. television power on;
g. television channel change;
h. television program change;
i. periodically; and
j. new user login.

20. The method of claim 17, wherein said available information includes data selected from one of the following:
a. television programming guide information;
b. regional ratings table;
c. extended data service;
d. user input;
e. internal calendar;
f. internal clock; and
g. user login information.
